(19) United States
(12) Patent Application Publication
(10) Pub. No.: US 2005/0276481 A1
(43) Pub. Date: Dec. 15, 2005

(54) Particular-region detection method and apparatus, and program therefor

(75) Inventor: Jun Enomoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIPHOTO FILM CO., LTD.

(21) Appl. No.: 11/142,675

(22) Filed: Jun. 2, 2005

(30) Foreign Application Priority Data
Jun. 2, 2004 (JP) 2004-164904

(51) Int. Cl. G06K 9/46; G06K 9/40

(52) U.S. Cl. 382/190; 382/275

(57) ABSTRACT

The method and apparatus for detecting particular regions detect one or more particular region candidates in a first image, perform face detection in a region including at least one of the thus detected particular region candidates by using a second image having a scene as same as the first image in which the particular region candidates are detected, but being different in resolution from the first image, and specify as a particular region of a detection target a particular region candidate that is included in the region where a face can be detected. The program for detecting particular regions causes a computer to execute the method.

This application claims priority on Japanese patent application No. 2004-164904, the entire contents of which are hereby incorporated by reference. In addition, the entire contents of literatures cited in this specification are incorporated by reference.

### BACKGROUND OF THE INVENTION

The present invention belongs to a technical field of image processing for detecting any possible particular region such as a red eye or golden eye in a face region from an image shot on a photographic film or an image taken by a digital camera. More particularly, the present invention relates to a particular-region detection method and apparatus which enable high-speed detection of a red eye or a golden eye from an image, and a particular-region detection program for implementing the same.

In recent years, a digital photoprinter has been put to practical use. The digital photoprinter photoelectrically reads an image recorded on a film, converts the read image into a digital signal, subsequently executes various image processing to convert the digital signal into image data for recording, exposes a photosensitive material to recording light modulated in accordance with the image data, and outputs the image as a print.

In the digital photoprinter, an image shot on a film is photoelectrically read, the image is converted into digital image data, and image processing and photosensitive material exposure are executed. Accordingly, a print can be created from not only an image shot on a film but also an image (image data) taken by a digital camera or the like.

Along with recent popularization of personal computers (PCs), digital cameras, and inexpensive color printers such as an ink-jet printer, many users load images taken by the digital cameras into their PCs, carry out image processing, and output the images by using the printers.

In addition, there has recently been put to practical use a printer for directly reading image data from a storage medium storing an image taken by a digital camera, executing predetermined image processing, and outputting a print (hard copy). Examples of the storage medium include a magneto-optical recording medium (MO or the like), a compact semiconductor memory medium (Smart Media™, Compact Flash™, or the like), a magnetic recording medium (flexible disk or the like), and an optical disk (CD, CD-R, or the like).

Incidentally, in an image that contains an image of a person such as a portrait, the most important factor that determines the image quality is how the image of the person is finished. Thus, a red eye phenomenon that eyes (pupils) of the person look red because of the influence of an electronic flash during photographing is a serious problem.

In a conventional analog photoprinter that directly executes exposure of the film, red eye correction is very difficult. However, in the case of the digital image processing in the digital photoprinter or the like, red eyes are detected by image processing (image analysis), and the red eyes can be corrected by correcting luminance or saturation of the red eye regions.

An example of the method of detecting red eyes from an image prior to carrying out the red eye correction processing is a method in which a face is detected from an image through image data analysis, and then eyes or red circular regions are detected from the detected face. There have also been proposed various face detection methods used for the red eye detection.

For example, JP 2000-137788 A discloses a method of improving the accuracy of face detection in which a candidate region assumed to correspond to the face of a person is detected from an image, this candidate region is divided into a predetermined number of small blocks, a characteristic amount regarding the frequency or degree of a change in density or luminance is obtained for each small block, and the characteristic amount is collated with the pattern indicating a relation of characteristic amounts among the small blocks when the pre-created region corresponding to the face of the person is divided into the predetermined number of small blocks to thereby evaluate the accuracy of the face candidate regions and improve the accuracy of face detection.

JP 2000-148980 A discloses a method of improving the accuracy of face detection in which a candidate region assumed to correspond to the face of a person is detected from an image, a region assumed to be a body is set by using the face candidate region as a reference when the density of the face candidate region is within a predetermined range, and the accuracy of a detection result of the face candidate region is evaluated based on the presence of a region in which a density difference between the set body region and the face candidate region is equal to or less than a predetermined value, or based on the contrast of density or saturation between the face candidate region and the body candidate region.

Furthermore, JP 2000-149018 A discloses a method of improving the accuracy of face detection in which candidate regions assumed to correspond to the face of a person are detected from an image, the degree of overlapping is calculated for the detected candidate regions overlapping each other in the image, and the detected candidate regions are evaluated for the degree of overlapping to thereby determine that a region having a higher degree of overlapping is a face region with higher accuracy.

The face detection requires accuracy, and various analyses are necessary. Thus, ordinarily, the face detection must be performed in high-resolution image data (so-called fine-scan data in the case of image data read from a film, or taken-image data in the case of a digital camera) used for outputting a print or the like, and that causes a lot of time for detection.

Besides, there can be basically four directions of a face in a taken image depending on the orientation of a camera (horizontal and vertical positions and the like) during photographing. Here, if face directions are different, arraying directions of eyes, a nose, and the like naturally vary in vertical and horizontal directions in the image. Thus, to reliably detect the face, face detection must be performed in all the four directions in the image.

There are various face sizes in the image depending on object distances or the like. If face sizes are different in the image, the positional relation (distance) among eyes, a nose, and other portions naturally varies in the image. Thus, to reliably detect the face, face detection must be performed for various face sizes.

As a result, the red-eye correction processing takes much time because the red-eye detection, especially the face detection, becomes a rate-limiting factor. For example, in the case of the digital photoprinter, high-quality images free of red eyes can be consistently output, but the long processing time is a major cause of reduction in productivity.

In this connection, an electronic flash possibly used during photographing may cause a golden-eye phenomenon in which the eyes (pupils) of a person look golden, as well as a red-eye phenomenon in which the eyes (pupils) look red. Although not so serious as the red-eye phenomenon, the golden-eye phenomenon is another important problem in photographic images and the golden-eye correction involves difficulties similar to those of the red-eye correction.

### SUMMARY OF THE INVENTION

The present invention has been made to solve the problems inherent in the conventional art, and an object of the present invention is to provide a method of detecting a particular region, capable of detecting particular regions likely to be present in a face region in an image such as red eyes, golden eyes, or eye corners at a high speed, consistently outputting high-quality images free of red eyes and golden eyes, for example, and greatly improving printer productivity.

Another object of the present invention is to provide an apparatus for detecting a particular region which is used to implement the particular-region detection method.

Still another object of the present invention is to provide a program for implementing the particular-region detection method.

In order to attain the first object described above, the first aspect of the invention provides a method of detecting particular regions, comprising detecting one or more particular region candidates in a first image, performing face detection in a region including at least one of the thus detected one or more particular region candidates by using a second image having a scene as same as the first image in which the one or more particular region candidates are detected, but being different in resolution from the first image, and specifying as a particular region of a detection target a particular region candidate that is included in the region where a face can be detected.

Preferably, the particular regions include a region of a red eye or a golden eye.

Preferably, the first image in which the one or more particular region candidates are detected is a high-resolution image and the second image in which the face detection is performed is a low-resolution image.

Preferably, the first image in which the one or more particular region candidates are detected is a low-resolution image and the second image in which the face detection is performed is a high-resolution image.

Preferably, the high-resolution image includes one of first image data on an image taken by a digital camera and second image data obtained through fine scanning of an original image for producing an output image in an image reader, and the low-resolution image includes one of third image data obtained by thinning out pixels or reducing a size of the first image data taken by the digital camera, and fourth image data obtained through pre-scanning of the original image performed prior to the fine scanning in the image reader.

Preferably, the face detection is performed using data of face region clipping processing used to image density correction, the face region clipping processing being carried out prior to detection of the one or more particular region candidates.

In order to attain the first object described above, the first aspect of the invention also provides a method of detecting particular regions, comprising detecting one or more particular region candidates from a first image in fed image data, performing, prior to detection of the one or more particular region candidates, clipping processing of a face region for using to image density correction using a second image having a scene as same as the first image in which the one or more particular region candidates are detected, but being different in resolution from the first image, checking whether or not one of the one or more particular region candidates is included within the face region clipped by the face region clipping processing, and specifying as a particular region of a detection target a particular region candidate that is included within the face region.

In order to attain the second object described above, the second aspect of the invention provides an apparatus for detecting particular regions, comprising candidate detection means for detecting one or more particular region candidates from a first image in fed image data, face detection means for detecting a face in a region including the one or more particular region candidates detected by the candidate detection means by using a second image having a scene as same as the first image in which the one or more particular region candidates are detected by the candidate detection means, but being different in resolution from the first image, and specifying means for specifying as a particular region of a detection target a particular region candidate that is included in the region where a face can be detected by the face detection means.

Preferably, the particular regions include a region of a red eye or a golden eye.

It is preferable that the apparatus further comprises selecting means for selecting one of a first detection mode in which the candidate detection means performs detection with a high-resolution image and the face detection means performs detection with a low-resolution image, and a second detection mode in which the candidate detection means performs detection with the low-resolution image and the face detection means performs detection with the high-resolution image.

Preferably, the high-resolution image includes one of first image data on an image taken by a digital camera and second image data obtained through fine scanning of an original image for producing an output image in an image reader, and the low-resolution image includes one of third image data obtained by thinning out pixels or reducing a size of the first image data taken by the digital camera, and fourth image data obtained through pre-scanning of the original image performed prior to the fine scanning in the image reader.

Preferably, the face detection means performs face detection using data of face region clipping processing used to image density correction, the face region clipping processing being carried out prior to detection of the one or more particular region candidates.

In order to attain the second object described above, the second aspect of the invention also provides an apparatus for detecting particular regions, comprising candidate detection means for detecting one or more particular region candidates from a first image in fed image data, face detection means for performing, before the one or more particular region candidates is detected in the candidate detection means, clipping processing of a face region for using to image density correction using a second image having a scene as same as the first image in which the one or more particular region candidates are detected in the candidate detection means, but being different in resolution from the first image, and specifying means for checking whether or not one of the one or more particular region candidates detected by the candidate detection means is included within the face region clipped by the face detection means, and specifying as a particular region of a detection target a particular region candidate that is included within the face region.

In order to attain the third object described above, the third aspect of the invention provides a program for detecting particular regions, which causes a computer to execute a candidate detection step of detecting one or more particular region candidates from a first image in fed image data, a face detection step of detecting a face in a region including the one or more particular region candidates detected in the candidate detection step by using a second image having a scene as same as the first image in which the one or more particular region candidates are detected in the candidate detection step, but being different in resolution from the first image, and a specifying step of specifying as a particular region of a detection target a particular region candidate that is included in the region where a face can be detected in the face detection step.

Preferably, the particular regions include a region of a red eye or a golden eye.

Preferably, the first image in which the one or more particular region candidates are detected is a high-resolution image and the second image in which the face detection is performed is a low-resolution image.

Preferably, the first image in which the one or more particular region candidates are detected is a low-resolution image and the second image in which the face detection is performed is a high-resolution image.

Preferably, the high-resolution image includes one of first image data on an image taken by a digital camera and second image data obtained through fine scanning of an original image for producing an output image in an image reader, and the low-resolution image includes one of third image data obtained by thinning out pixels or reducing a size of the first image data taken by the digital camera, and fourth image data obtained through pre-scanning of the original image performed prior to the fine scanning in the image reader.

Preferably, the face detection is performed using data of face region clipping processing used to image density correction, the face region clipping processing being carried out prior to detection of the one or more particular region candidates.

In order to attain the third object described above, the third aspect of the invention also provides a program for detecting particular regions, which causes a computer to execute a candidate detection step of detecting one or more particular region candidates from a first image in fed image data, a face detection step of performing, before the one or more particular region candidates is detected in the candidate detection means, clipping processing of a face region for using to image density correction using a second image having a scene as same as the first image in which the one or more particular region candidates are detected in the candidate detection step, but being different in resolution from the first image, a checking step of checking whether or not one of the one or more particular region candidates detected by the candidate detection step is included within the face region clipped by the face detection step, and a specifying step of specifying as a particular region of a detection target a particular region candidate that is included within the face region.

With the configuration of the present invention, upon the detection of any particular region in the face region of an image such as a red eye, a golden eye, or a pimple, face detection in a region including no particular region is not necessary, and the calculation amount and processing time can be reduced. This makes it possible to detect a particular region in a face region such as a red eye or golden eye at a high speed.

Thus, according to the particular-region detection method of the present invention, for example, high speed red eye or golden-eye detection enables quick red eye or golden-eye correction. For example, in the photoprinter with which a photographic print is created from image data obtained by photoelectrically reading a photographic film, image data captured by a digital camera, or the like, it is possible to minimize reduction in productivity and consistently output high image-quality prints free of red eyes and golden eyes.

### BRIEF DESCRIPTION OF THE DRAWINGS

In the accompanying drawings:

FIG. 1 is a conceptual block diagram showing an example of a red-eye detection apparatus to which a particular-region detection apparatus according to the present invention is applied;

FIG. 2 is a conceptual diagram illustrating how to detect a red eye according to the present invention;

FIG. 3 is a conceptual diagram illustrating how to detect a red eye according to the present invention;

FIGS. 4A and 4B are conceptual diagrams each illustrating how to detect a face with the red-eye detection apparatus shown in FIG. 1;

FIG. 5 is a block diagram showing an embodiment of an image processor including the red-eye detection apparatus to which the particular-region detection apparatus according to the present invention is applied;

FIG. 6 is a flowchart showing an example of a flow of calculation processing for gray scale correction amounts and gray scale adjustment amounts carried out with an image setup apparatus of the image processor shown in FIG. 5;

FIG. 7 is a flowchart showing another example of the flow of calculation processing for gray scale correction amounts and gray scale adjustment amounts carried out with the image setup apparatus of the image processor shown in FIG. 5; and

FIG. 8 is a block diagram showing another embodiment of the image processor including the red-eye detection apparatus to which the particular-region detection apparatus according to the present invention is applied.

### DETAILED DESCRIPTION OF THE PREFERRED EMBODIMENTS

The particular-region detection method and apparatus, and the program therefor according to the present invention will be described below in detail with reference to the preferred embodiments shown in the accompanying drawings. In the following description, detection of a red eye as a particular region likely to be present in a face region of an image will be taken as a typical example. However, the present invention is not limited to this example. Needless to say, the present invention is also applicable to the detection of golden eyes and so forth.

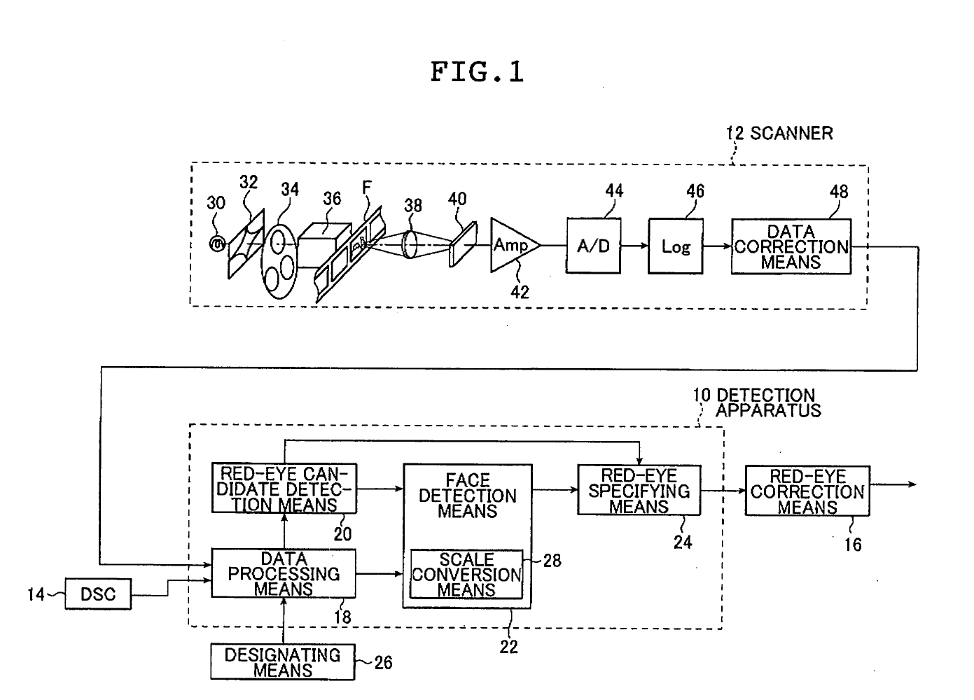

FIG. 1 is a conceptual block diagram of an embodiment of a red-eye detection apparatus using a particular-region detection method and apparatus of the present invention. In addition, a particular-region detection program of the present invention causes a computer to execute the following processing.

A red-eye detection apparatus (hereinafter referred to as detection apparatus) 10 shown in FIG. 1 acquires an image to be processed (image data thereof) from an image data source, for example, a scanner 12 or a digital camera 14 such as a digital still camera (DSC) or digital video camera (and/or reading means of a storage medium or recording medium storing an image taken by the digital camera 14), detects a red eye as a particular region from the image to be processed (hereinafter referred to as target image), and outputs the detection result to a red-eye correction means 16. The red-eye detection apparatus 10 includes a data processing means 18, a red-eye candidate detection means 20, a face detection means 22, a red-eye specifying means 24, and a designating means 26 externally connected.

The detection apparatus 10 is configured for example using a computer such as a personal computer or a workstation, a OSP (digital signal processor) or the like.

The detection apparatus 10 and the red-eye correction means 16 may be constructed integrally, or the detection apparatus 10 (or the detection apparatus 10 and the red-eye correction means 16) may be incorporated in an image processor (means) for performing various image processing such as color/density correction, gray scale correction, electronic magnification, and sharpness processing.

In the detection apparatus 10, the target image is not limited to an image read with the scanner 12 or an image taken with the digital camera (hereinafter typified by DSC) 14 but may be selected from a wide variety of color images (data). Needless to say, the target image may be an image (image data) subjected to various image processing as needed.

Since the present invention is not limited to the detection of red eyes but also applicable to the detection of golden eyes and so forth, an image to be subjected to golden-eye detection, as well as an image to be subjected to red-eye detection, will do as the target image for the detection apparatus 10 of the invention.

The red-eye and golden-eye phenomena are described in detail in JP 2000-76427 A. In the red-eye phenomenon, eyes (pupils) of a person in a taken image look red due to, for instance, an electronic flash used during photographing. To be more specific, a large quantity of light from the electronic flash is incident on the retinae of the open eyes of the person through the pupils and then reflected from the retinae to form an image on a photographic film or an image pickup device such as CCD after passing through a lens of a camera. Many blood vessels are concentrated at the retinae so that the eyes (pupils) of the person in the taken image look red. The golden-eye phenomenon is different a bit from the red-eye phenomenon. When a large quantity of light is incident on the retinae of the open eyes of the person through the pupils, parts of the incident light may be reflected from the blind spots which are points on the retinae where nerves are concentrated. If such reflected light forms an image on a film and so forth in a camera, the golden-eye phenomenon will occur, that is to say, the eyes (pupils) of the person in the taken image do not look red but golden. The red-eye and golden-eye phenomena as above may occur in the eyes not only of a human being but also an animal such as cat. Depending on its kind, the animal in a taken image may have the eyes in a color other than red or golden color.

In the following, the red eye is described as a representative of phenomena in which the eyes of a person or animal in a taken image look red or golden, or has another color.

The scanner 12 as the image data source is a well-known film scanner (film image reader) for photoelectrically reading an image shot on a film F such as a negative film or a reversal film frame by frame.

The illustrated scanner 12 reads an image of each frame through planar exposure using an area CCD sensor. However, this is not the sole scanner that can be used in the present invention but a scanner for reading an image through so-called slit scanning may be used instead in which the image is read using three line CCD sensors for R (red), G (green) and B (blue) extending in a direction orthogonal to the transport direction while the film F is transported in a longitudinal direction.

The scanner 12 basically include a light source 30, a variable diaphragm 32, a color filter plate 34 which includes three color filters of R, G, and B for separating an image into three primary colors of R, G, and B and which rotates to have either one of these color filters inserted into the optical path, a diffusion box 36 which diffuses the reading light incident on the film F so that it becomes uniform across the plane of the film F, an imaging lens unit 38, a CCD sensor 40 as the area sensor which reads the image in one frame of the film, an amplifier 42, an analog/digital (A/D) converter 44, a Log converter 46 and a data correction means 608.

In the above scanner 12, light is emitted from the light source 30, subjected to light amount adjustment with the variable diaphragm 32, passed through the color filter plate 34 for color adjustment, and diffused with the diffusion box 36. Then, this read light enters the film F and passes therethrough, thereby obtaining projected light representative of the image of this frame shot on the film F.

The projected light from the film F is imaged on the light-receiving plate of the CCD sensor 40 by the imaging lens unit 38 and photoelectrically read by the CCD sensor 40.

The output signals from the CCD sensor 40 are amplified with the amplifier 42 and converted into digital data in the A/D converter 44. The digital data is subjected to log conversion in the Log converter 46 to obtain digital image (density) data. The digital image data is outputted from the scanner 12 after having undergone predetermined correction processing such as DC offset correction, dark current correction, and shading correction in the data correction means 608.

In the scanner 12, such image reading is performed three times, with the respective three color filters in the color filter plate 34 being inserted in succession so that the image in one frame is read as separations of three primary colors of R, G and B.

In the scanner 12, fine scan which reads an image at high resolution for obtaining an output image to be outputted as a print is preceded by prescan which reads the image at low resolution for setting the reading conditions for fine scan and determining the conditions for various image processing operations. The image data obtained through prescan (hereinafter, referred to as prescan data) and image data obtained through fine scan (hereinafter, referred to as fine-scan data) are both fed to the detection apparatus 10.

In the detection apparatus 10, a target image, that is, prescan data and fine-scan data of an image read with the scanner 12 and an image taken with the DSC 14 (image data thereof) are fed to the data processing means 18.

In a preferable embodiment of the illustrated detection apparatus 10, a first detection mode in which red eye candidates are detected in a high-resolution image and a face is detected in a low-resolution image to thereby detect red eyes, and a second detection mode in which red eye candidates are detected in a low-resolution image and a face is detected in the high-resolution image to thereby detect red eyes. One of them is selected to execute red eye detection.

The present invention is not limited to the above mode-selectable detection apparatus, but can adopt either a detection apparatus executing only red eye detection involving detection of red eye candidates in a high-resolution image, and detection of a face in a low-resolution image (first detection mode) or a detection apparatus executing only red eye detection involving detection of red eye candidates in a low-resolution image, and detection of a face in a high-resolution image (second detection mode).

Which mode is used for red eye detection is determined in response to a designation made by the designating means 26. The detection apparatus 10 detects red eyes from a target image in a mode designated with the designating means 26.

The designating means 26 is a well-known inputting/designating means which is used in a computer or the like and which performs inputting for various kinds of designation by means of the GUI (graphical user interface) using a keyboard, a mouse, a display, or the like.

When the first detection mode is selected in response to a designation made by the designating means 26, the data processing means 18 feeds a high-resolution image to the red-eye candidate detection means 20 and a low-resolution image to the face detection means 22. In contrast, when the second detection mode is selected, the low-resolution image is fed to the red-eye candidate detection means 20 and the high-resolution image is fed to the face detection means 22.

If the target image is fed from the scanner 12, the data processing means 18 sets the prescan data as a low-resolution image and the fine-scan data as a high-resolution image, and feeds the low-resolution and high-resolution images to the means appropriate for the designated mode. In addition, if the target image is fed from the DSC 14, the data processing means 18 sets the taken image (data) as a high-resolution image and an image (data) of a predetermined resolution obtained by thinning out the taken image (or by zooming out through electronic magnification), as a low-resolution image, and feeds each of the low-resolution and high-resolution images to the means appropriate for the designated mode.

Further, when the target image is image data on a negative film which was fed from the scanner 12, the image is converted from a negative form to a positive form and fed to each portion. (It is also possible to convert the image from a positive form to a negative form.) Note that the negative-positive conversion may be carried out by any well-known method such as a method using a lookup table or a method based on calculation processing.

The red-eye candidate detection means 20 detects a region likely to form a red eye image, i.e., one or more red eye candidates (red eye region candidates), from a target image, and feeds positional information of the red eye candidates (information on the central coordinate position), region information, information on the number of candidates, and the like as red eye candidate information to the face detection means 22 and the red-eye specifying means 24. That is, in the first detection mode, red eye candidates are detected from a target image using a high-resolution image. In the second detection mode, red eye candidates are detected from a target image using a low-resolution image.

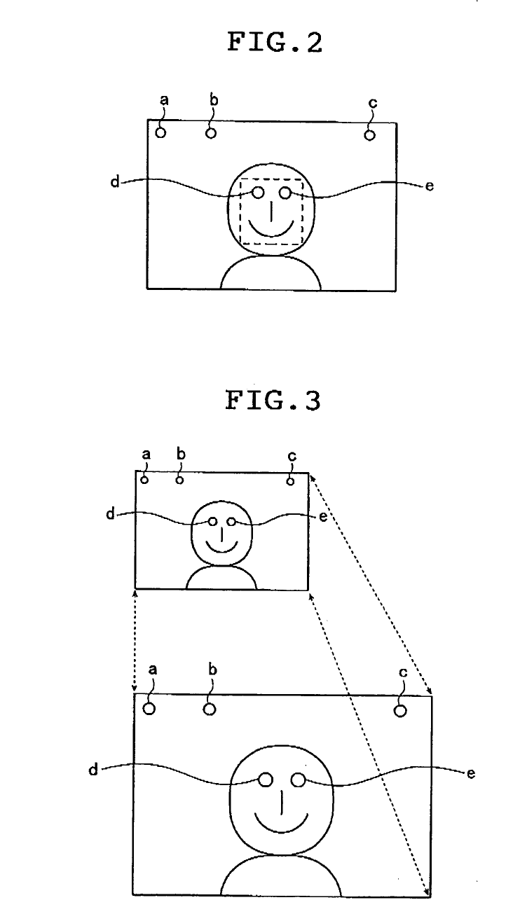

To give an example thereof, as shown in FIG. 2, a person is photographed in a scene having three red lamps on the background. If the taken image (scene) of the person involves a red eye phenomenon, “a” to “c” corresponding to the red lamps, and regions indicated by “d” and “e” corresponding to red eyes are detected as red eye candidates and fed to the face detection means 22 and the red-eye specifying means 24.

There is no particular limitation on the method of detecting red eye candidates but various known methods may be used.

A method is illustrated in which a red hue region having not less than a predetermined number of pixels is extracted, and a region whose degree of red eye (to what extent the red color of the eye is close to red eye) and roundness (to what extent the red is round) exceed a given degree of red eye and a given roundness which are preset based on many red eye image samples and used as threshold values is detected as a red eye candidate having a possibility of red eye.

The red eye candidates are detected by the red-eye candidate detection means 20 and the detection result obtained is sent to the face detection means 22.

The face detection means 22 executes face detection in the region surrounding the red eye candidate detected by the red-eye candidate detection means 20 based on the red eye detection result (e.g., the positional information), and feeds information on the red eye candidate in the region of which a face could be detected and optionally the face detection result to the red-eye specifying means 24.

For example, in the example shown in FIG. 2, face detection is sequentially performed in predetermined regions including the red eye candidates corresponding to the red eye candidates “a” to “e”. As a result, a region surrounded by the dotted line is detected as a face region, for example, and the face detection means 22 feeds information indicating that the red eye candidates “d” and “e” are red eye candidates included in the face region and optionally information on the detected face region to the red-eye specifying means 24 correspondingly.

In the detection apparatus 10, the face detection means 22 detects a face from a target image using a low-resolution image in the first detection mode or using a high-resolution image in the second detection mode. That is, an image whose resolution is different from that in the red-eye candidate detection means 20 is used to perform the face detection on the periphery of the red eye candidate detected by the red-eye candidate detection means 20.

As schematically shown in FIG. 3, the face detection means 22 includes a scale conversion means 28. The face detection means 22 subjects an image to scale conversion in the scale conversion means 28 to perform positional alignment in accordance with the resolution of the image whereby the face detection is performed. To give an example, with the first detection mode, the position of the red eye candidate detected from the high-resolution image is aligned through scale conversion (coordinate transformation) that zooms out the image in correspondence with the low-resolution image. Then, the face is detected from a region surrounding the red eye candidate with the low-resolution image. On the other hand, with the second detection mode, the position of the red eye candidate detected from the low-resolution image is aligned through scale conversion (coordinate transformation) that zooms in the image in correspondence with the high-resolution image. Then, the face is detected from a region surrounding the red eye candidate with the high-resolution image.

There is no particular limitation on the face detection method by the face detection means 22 but various known methods may be used.

A method is illustrated in which a face is detected through template matching using an average face image previously prepared from a large number of face image samples, i.e., a template of a face (hereinafter referred to as a “face template”).

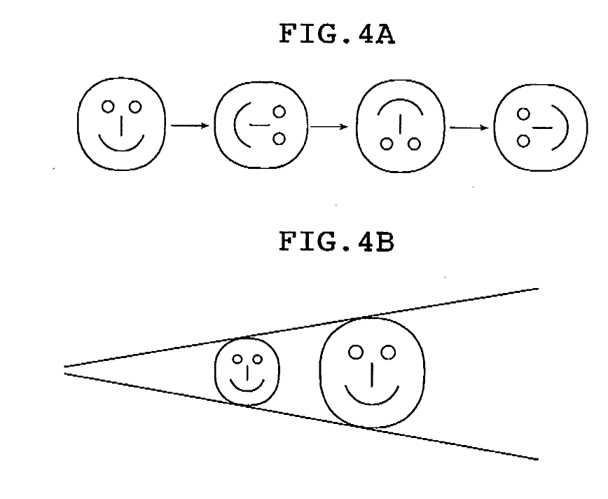

With this method, as shown in FIG. 4A, a face template (or target image) is rotated in vertical and horizontal directions (rotated in the order of 0°, 90°, 180°, and 270° on an image surface) in accordance with a camera's posture at the time of photographing, for example, portrait orientation (portrait photographing) and landscape orientation (landscape photographing) to thereby change the orientation of the face. In addition, as shown in FIG. 4B, the face size of the face template (as mentioned above) is changed (zoom-in/zoom-out=resolution change) in accordance with the face size (resolution) in an image, followed by comparison between a face candidate region in an image and face templates of varying combinations of the face orientations and face sizes for template matching (checking the matching level) one by one to detect the face.

It is also possible to previously prepare the rotated face templates and zoomed-in/out face templates for template matching instead of rotating the face template and zooming in/out the template. Also, the face candidate region detection may be performed with, for example, a skin color extraction means or contour extraction means.

The face detection based on a learning method is also preferably illustrated.

With this method, many face images and non-face images are prepared, and characteristic amounts of the respective images are extracted. Extraction results are used for pre-learning directed to calculate a function or threshold value for separating a face (face region) from non-face (non-face region) based on a learning method selected as appropriate. Upon the face detection, characteristic-amount extraction is carried out on a target image as in the pre-learning to judge whether the target image is the face image or non-face image using the function or threshold value obtained in the pre-learning whereby the face detection is performed.

Given as other applicable methods are a face detection method based on shape recognition utilizing edge (contour) extraction or extraction in an edge direction, a face detection method utilizing color extraction such as skin color extraction or black extraction, and a face detection method utilizing a combination of shape recognition and color extraction as disclosed in JP 08-184925 A and JP 09-138471 A, and the methods cited in JP 2000-137788 A, JP 2000-148980 A, and JP 2000-149018 A as the method of detecting a face candidate except the matching method using a face template.

In the illustrated detection apparatus 10, the first detection mode and the second detection mode may be different in the face detection method or a desired face detection method may be set in response to a designation made with the designating means 26.

Further, in the first detection mode or in the case where red-eye detection is performed only through red-eye candidate detection with a high-resolution image and face detection with a low-resolution image, it is preferable to detect a face through template matching that is implementable even with the low-resolution image or through skin color extraction. In particular, the face detection based on the skin color extraction etc. is preferred for speed-oriented processing although detection precision is lowered because the face detection does not depend on the resolution.

As described above, the detection result of the red-eye candidates with the red-eye candidate detection means 20, and the red-eye candidates around which the faces could be detected by the face detection means 22 are fed to the red-eye specifying means 24.

By using the information, the red-eye specifying means 24 specifies the red-eye candidate around which the face could be detected as a red eye, and feeds positional information on the red eye, information on the region of the red-eye, information on the number of red eyes, or the like as red-eye detection results in the target image to the red-eye correction means 16.

As described above, according to the present invention, the red-eye candidate detection is first carried out, and then the face detection is performed only on a region surrounding the detected red-eye candidate. Then, the red-eye candidate around which the face could be detected is specified as a red eye. In addition, the red-eye candidate detection and face detection are performed using images of different resolutions, whereby a time period necessary for the red-eye detection can be considerably reduced.

That is, as mentioned above, the face detection is time-consuming processing, and furthermore, the conventional red-eye detection method involves face detection and then red-eye detection within the detected face region, which means that the face detection is carried out even on a region including no red eye. As a result, the face detection takes so much time to execute. In contrast, according to the present invention, the red-eye candidate is detected, after which the face detection is carried out only on a predetermined region including the red-eye candidate, which eliminates unnecessary face detection in the region including no red eye and thus considerably shortens the time period necessary for the face detection in the red-eye detection.

Moreover, images of different resolutions are used for the red-eye candidate detection and face detection, whereby the calculation amount and processing time can be considerably reduced while necessary and sufficient detection precision can be secured compared to the conventional red-eye detection based on only the high-resolution images.

That is, the present invention enables prompt red-eye correction through high-speed red-eye detection, and it is possible to minimize the productivity reduction and consistently output high-quality prints free of red eyes using a photoprinter, for instance.

The method of detecting a red-eye candidate using a high-resolution image and detecting a face using a low-resolution image to thereby detect a red eye (first detection mode) aims at high-precision detection of the red-eye candidate, that is, aims at the red-eye detection excelling in red-eye detection performance. Therefore, in the case of placing greater importance on the detection performance (so-called false positive (FP) detection), such red eye detection is preferred.

In contrast, the method of detecting a red-eye candidate using a low-resolution image and detecting a face using a high-resolution image to thereby detect a red eye (second detection mode) aims at high-precision face detection, that is, aims at the face detection suitable for preventing erroneous red-eye detection. Therefore, in the case of placing importance on the performance for preventing erroneous detection (so-called true positive (TP) detection), such red eye detection is preferred.

In accordance with the red-eye detection result fed from the red-eye specifying means 24, the red-eye correction means 16 executes image processing of the red-eye region of the target image to correct the red eyes of the target image.

There is no particular limitation on the red-eye correction method but various known methods may be used. Given as examples thereof are correction processing for correcting a red eye by controlling saturation, brightness, a hue, or the like of a red-eye region in accordance with an image characteristic amounts of the red eye and its vicinities (it may include a region surrounding a face), and correction processing for simply converting a color of the red-eye region into black.

The image (image data) whose red-eye phenomenon was corrected by the red-eye correction means 16 is outputted as it is or after being subjected to other image processing, for example. The outputted image is then recorded on a recording or storage medium, displayed on a display screen of an image display apparatus, or printed by use of a printer, in particular, a digital photoprinter.

Next, the present invention will be described in further detail by explaining the function of the detection apparatus 10.

To give an example, it is assumed that a target image is fed from the scanner 12, and the designating means 26 designates the first detection mode.

Receiving the target image, the data processing means 18 feeds the fine-scan data to the red-eye candidate detection means 20 as a high-resolution image of the target image and the prescan data to the face detection means 22 as a low-resolution image of the target image in accordance with the designated first detection mode.

If the target image is negative image data, the date processing means 18 subjects the image to negative/positive conversion and feeds a resulting image to a corresponding site. Also, if the target image is supplied from the DSC 14, the taken image is fed to the red-eye candidate detection means 20 as the high-resolution image, and an image obtained by thinning out the taken image (or zoomed out image) is fed to the face detection means 22 as the low-resolution image.

The red-eye candidate detection means 20 carries out the red-eye candidate detection using the fed fine-scan data of the target image (high-resolution image data, hereinafter typified by the fine-scan data) in the manner mentioned above, and feeds the detected red-eye candidates to the face detection means 22 and the red-eye specifying means 24.

Receiving the prescan data (low-resolution image data: hereinafter typified by the prescan data) of the target image and the detected red-eye candidate, the face detection means 22 first executes scale conversion so as to zoom out the image with the scale conversion means 28 and adjusts the position of the detected red-eye candidate in the fine-scan data to the position corresponding to the prescan data. Next, the face detection means 22 performs the face detection in a surrounding region including the red-eye candidate detected with the red-eye candidate detection means 20 using the prescan data, and feeds the face detection result to the red-eye specifying means 24.

The red-eye specifying means 24 specifies the red-eye candidate around which the face could be detected, as a red eye based on the red-eye candidate detected with the red-eye candidate detection means 20 and the face detected with the face detection means 22, and feeds the red-eye detection result to the red-eye correction means 16.

The red-eye correction means 16 performs the red-eye correction on the target image (in this example, fine-scan image thereof) as mentioned above, based on the fed red-eye detection result.

Meanwhile, if the second detection mode is designated, the data processing means 18 obtains the target image and then feeds the prescan data (image obtained by thinning out the taken image or zoomed out image) to the red-eye candidate detection means 20 as the low-resolution image of the target image, and fine-scan data (taken image) to the face detection means 22 as the high-resolution image of the target image.

The red-eye candidate detection means 20 performs the red-eye candidate detection using the fed prescan data of the target image as mentioned above, and feeds the result on the red-eye candidate detection to the face detection means 22 and the red-eye specifying means 24.

Further, the face detection means 22 executes scale conversion so as to zoom in the image with the scale conversion means 28 and adjusts the position of the detected red-eye candidate in the prescan data to the position corresponding to the fine-scan data. Next, the face detection means 22 performs face detection in a region surrounding the red-eye candidate detected with the red-eye candidate detection means 20 using the fine-scan data, and feeds the face detection result to the red-eye specifying means 24.

The red-eye specifying means 24 specifies the red-eye candidate around which the face could be detected, as a red eye based on the red-eye candidate detected with the red-eye candidate detection means 20 and the face detected with the face detection means 22, and feeds the red-eye detection result to the red-eye correction means 16.

The red-eye correction means 16 performs the red-eye correction on the target image as mentioned above, based on the fed red-eye detection result.

According to the above embodiment, in the red-eye detection apparatus 10, the face detection means 22 performs face detection in a surrounding region including a red-eye candidate detected with the red-eye candidate detection means 20 using a detection result such as positional information on the red-eye candidate detected with the red-eye candidate detection means 20. However, the present invention is not limited to this, and when the target image of the red-eye detection apparatus 10 is an image processed using the face extraction result (image data), the face detection means 22 of the red-eye detection apparatus 10 may utilize data on clipped face region as a face extraction result used for image density correction of the image processing for face detection.

That is, in general, an image processor for a printer, photoprinter or the like, overall image processing such as density correction, color balance correction, or gray scale correction (setup processing or automatic setup processing) is performed on the image (image data). In such image processing, the face detection based on the face extraction etc. may be performed for enhancing the processing accuracy or improving or correcting the processing result (see commonly assigned Japanese Patent Application Nos. 2005-071352 and 2005-074560).

Therefore, if the particular-region detection apparatus like the red-eye detection apparatus according to the present invention is incorporated into or connected to such an image processor, the result of image processing with the image processor, that is, the face detection result obtained through the setup processing (data on the clipped face region) is utilized for face detection in a surrounding region including a particular-region candidate such as a red-eye candidate detected by the particular-region candidate detection means. Thus, upon the face detection through the particular-region detection, the calculation amount or processing time can be considerably reduced while the necessary and sufficient detection accuracy is secured. As a result, the prompt red-eye correction is realized, so it is possible to minimize the productivity reduction and consistently output high-quality prints free of red eyes using a photoprinter, for instance.

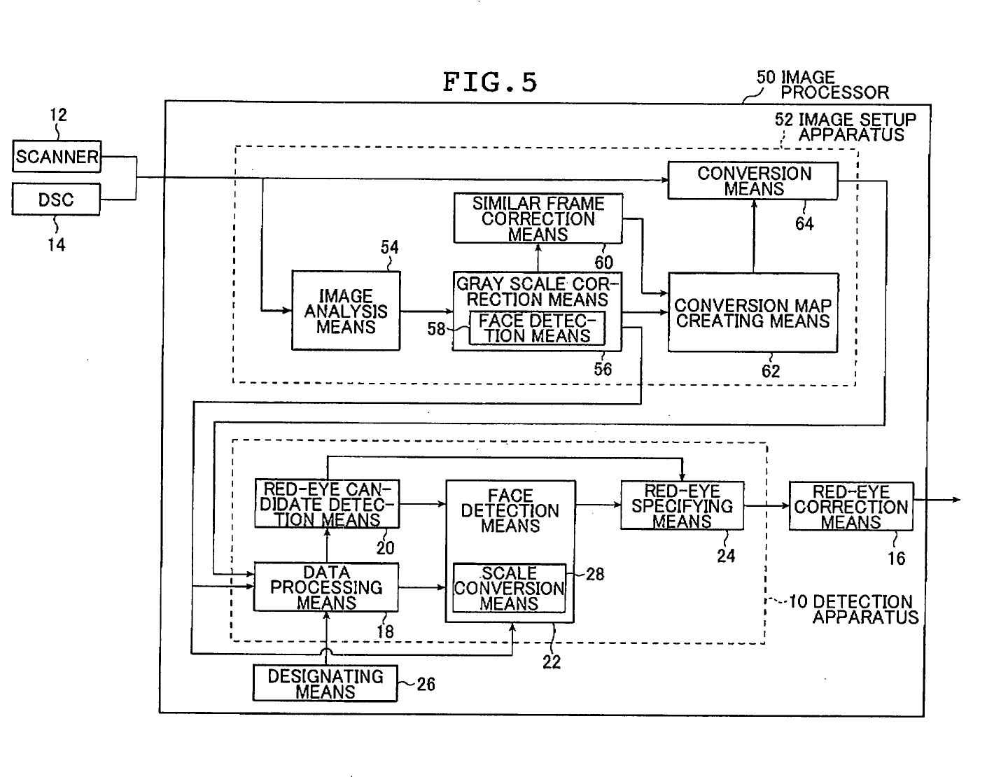

FIG. 5 is a block diagram of an embodiment of an image processor including a red-eye detection apparatus to which a particular-region detection apparatus implementing the particular-region detection method of the present invention is applied.

An image processor 50 shown in FIG. 5 includes the red-eye detection apparatus 10 shown in FIG. 1, and an image setup apparatus 52 that is interposed between the scanner 12 or digital camera (DSC) 14 as an image data source and the red-eye detection apparatus 10, so like components are denoted by like numerals, and their detailed description is accordingly omitted.

As shown in FIG. 5, the image processor 50 includes the image setup apparatus 52 which receives a target image as image data from the image data source, for example, the scanner 12 or the digital camera (hereinafter referred to as DSC) 14, subjects the received image to digital image processing, and automatically sets image processing conditions for creating a reproduction image, and subjects the resultant image to image processing based on the set image processing conditions (auto-setup processing); the red-eye detection apparatus 10 according to the present invention for detecting a red eye as a particular region from the processed image data of the target image; the red-eye correction means 16 for correcting the detected red eye; and the designating means 26 externally connected.

As the image processor 50, a computer such as a personal computer or workstation mounted with a DSP (digital signal processor) specialized in digital signal processing can be used as in the red-eye detection apparatus 10.

The image setup apparatus 52 performs the auto-setup calculation for the image processing conditions using the low-resolution image data (prescan data) roughly read by the CCD sensor 40 (see FIG. 1) of the scanner 12 or other image sensors from the image shot on a negative film or the low-resolution image data resulting from thinning-out processing on the high-resolution image data supplied from the DSC 14, sets a conversion map of the image processing conditions by calculation, and converts the image data (fine scan data) finely read for print output into the set-up image data using the automatically set conversion map. In this way, the low-resolution image data such as prescan data and the set-up image data (high-resolution image data) obtained with the image setup apparatus 52 are inputted to the red-eye detection apparatus 10.

The image setup apparatus 52 includes an image analysis means 54, a gray scale correction means 56, a similar-frame correction means 60, a conversion map creating means 62, and a conversion means 64.

The image analysis means 54 analyzes prescan data or low-resolution image data (hereinafter typified by prescan data) of plural frames corresponding to one load from the scanner 12 or DSC 14, creates a three-dimensional table T referenced by the gray scale correction means 56, analyzes an image of one frame, and calculates an image characteristic amount etc.

Here, in order to create the three-dimensional table T, image data on images corresponding to one load should be accumulated. Hence, as the image data used herein, preferably, the prescan data is further thinned out to obtain lower-resolution image data. Note that the size of the data obtained by further thinning out the prescan data in the image analysis means 54 varies depending on the type of a digital photoprinter or the like and there is no particular limitation.

The gray scale correction means 56 includes a face detection means 58, and sets as image processing conditions a gray scale correction amount of an input image (image data) by calculation so as to obtain appropriate color/density or gray scale of an overall image in a reproduction image such as a photoprint or an image displayed on a monitor, but also appropriate color/density or gray scale of a main subject in a face region detected with the face detection means 58. That is, the gray scale correction means 56 calculates a gray scale correction amount of an image and the like by sequentially performing the face extraction, gray balance correction (load-basis gray balance correction), color balance correction (frame gray balance correction), under/over correction, density correction, and contrast correction on the prescan data inputted from the image analysis means 54. The calculation processing for the gray scale correction amount and the like carried out by the gray scale correction means 56 will be described later in detail.

The data on the clipped face region obtained as the face extraction result in the face detection effected with the face detection means 58 is inputted from the face detection means 58 of the gray scale correction means 56 to the face detection means 22 of the red-eye detection apparatus 10 directly or through the data processing means 18. Note that the data on the clipped face region obtained in the face detection means 58 may be inputted to the red-eye detection apparatus 10 together with the set-up image data or prescan data through the conversion map creating means 62 and the conversion means 64, and then inputted to the face detection means 22 through the data processing means 18.

The similar frame correction means 60 calculates gray scale correction amounts of input images (image data) between similar frames as image processing conditions so that images of similar frames in one load for example are reproduced with a similar quality to give uniform finishing quality to the reproduced images of similar frames. That is, the similar frame correction means 60 performs the similar frame correction processing of the color balance correction (frame gray balance correction), the similar frame correction processing of the density correction, and the similar frame correction processing of the contrast correction on the similar frame image (image data) whose gray scale is corrected by the gray scale correction means 56 to thereby calculate the color balance adjustment amount, the density adjustment amount, and the contrast adjustment amount.

The conversion map creating means 62 automatically creates a conversion map for processing an input image (image data) such as a fine scan image (fine scan data) of an original image or an image taken by a OSC (high-resolution image data) (hereinafter typified by fine scan data), for example, a conversion function or a lookup table (LUT) created by mapping the conversion function into a table, or a conversion matrix obtained through matrix calculation of the conversion function, based on each correction amount obtained from the gray scale correction means 56, and each adjustment amount obtained from the similar frame correction means 60, thereby setting these as the conversion map.

Note that the map set as the conversion map may be a single map created by combining all correction amounts and adjustment amounts or a map obtained by combining maps each created based on one or more correction amounts or adjustment amounts.

When the fine scan data is inputted to the image processor 50, the conversion means 64 converts the fine scan data in accordance with the automatically set conversion map (conversion function, LUT, or conversion matrix) to obtain the set-up image data.

In this way, the image setup apparatus 52 effects the image condition setting and conversion (auto-setup processing).

Thus, the set-up image data and prescan data obtained in the image setup apparatus 52 are inputted to the data processing means 18 of the red-eye detection apparatus 10. Note that as mentioned above, the data on the clipped face region obtained in the face detection means 58 is also inputted to the face detection means 22 of the red-eye detection apparatus 10 directly or through the data processing means 18.

Next, detailed description is given of the calculation processing for the gray scale correction amount and gray scale adjustment amount carried out in the image setup apparatus 52, that is, the calculation processing for the image gray scale correction amount carried out with the gray scale correction means 56, and the calculation processing for the gray scale adjustment amount of the similar frame image carried out with the similar frame correction means 60, more specifically, the image analysis processing carried out with the image analysis means 54, the gray scale correction processing carried out with the gray scale correction means 56, and the similar frame correction processing carried out with the similar frame correction means 60.

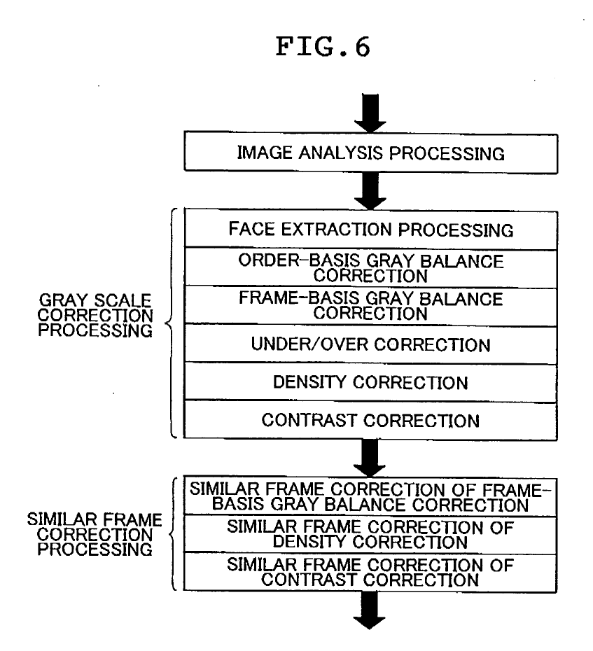

FIG. 6 is a flowchart showing an example of a flow of calculation processing for gray scale correction amounts and gray scale adjustment amounts carried out in the image setup apparatus.

With the image analysis processing carried out in the image analysis means 54, the image analysis is performed on the input image data (prescan data or low-resolution image data). More specifically, in the image analysis processing, the image analysis means 54 creates the three-dimensional table T of R, G, B used for gray balance correction (load-basis gray balance correction) in the gray scale correction processing carried out with the gray scale correction means 56 on the prescan data of images of plural frames of a negative film corresponding to one load obtained with the scanner 12 or low-resolution image data of a predetermined number of images corresponding to one load obtained with the DSC 14 by extracting low-saturation pixels from those image data. Note that the prescan data used for correcting image data represents RGB density values in a digital photoprinter on which the image processor 50 is mounted.

Also, in the image analysis processing, the image analysis is performed on an image of one frame with the image analysis means 54 to calculate the image characteristic amounts thereof or the like.

In the gray scale correction processing, the face extraction processing with the face detection means 58, the load-basis gray balance correction (gray balance correction), frame gray balance correction (color balance correction), under/over correction, density correction, and contrast correction are performed on the input image data with the gray scale correction means 56 in this order to calculate the gray scale correction amounts of the image.

In the face extraction processing, the face detection means 58 effects the face extraction processing using the gray image (gray scale image) of the prescan image (low-resolution image), that is, gray information (gray scale information) derived from the prescan data. That is, a characteristic amount regarding the density gradient is derived from information on the density gradient in the gray image (luminance gradient) of the gray image (information on the direction and degree of a density change), and the face region in the image is extracted using the characteristic amount. Note that the information on the face region (data on clipped face region) extracted in the face extraction processing with the face detection means 58 is sent to the red-eye detection apparatus 10 (data processing means 18 or face detection means 22) as mentioned above. Note that in this embodiment, the gray information is used for the face extraction processing, so the face extraction processing can be performed even prior to the frame gray balance correction (color balance correction).

In this embodiment, as a preferred mode, the face detection means 58 effects the face extraction processing using a method in which the characteristic amount regarding the density gradient of the image is acquired from the prescan data, and a face region of a person is extracted from an image based on the acquired characteristic amount. With this method, the face region can be extracted without using color information such as skin color. Hence, the face extraction can be carried out with a sufficiently high precision even if the image color or density is not properly corrected. That is, with the face extraction method, the face extraction processing can be performed independently of the gray scale correction such as density correction or color balance correction, and thus can be carried out prior to the gray scale correction, so the face extraction result can be used for the gray scale correction processing such as the density correction or color balance correction.

Also, the face extraction method of this embodiment is preferable in terms of high precision in face extraction and high robustness. However, the face extraction method in the image processing of the present invention is not limited to this, but various methods other than the above method can be used as long as the method allows extraction of a face region without using color information. For example, a method based on the face image template matching using the luminance information can be used.

In the gray balance correction (load-basis gray balance correction) processing, the gray axis is optimized/approximated using data on regions within a density range of each color of R, G, and B in the image data on images of plural frames used for creating the lookup table T, based on the lookup table T created through the image analysis processing with the image analysis means 54, thereby calculating the gray balance correction amount. The gray balance correction amount is used for correcting the image data on plural images shot on a negative film corresponding to one load, for example, such that a gray image is displayed in gray by eliminating the influence of the film density. An END (equivalent neutral density)-LUT (equivalent neutral density table) is set by calculation based on the gray balance correction amount. Through this correction, a difference in image density due to a difference in film manufacturer or type can also be corrected. Note that even for the image data on images of a group of frames taken with the DSC 14, similarly calculated in the load-basis gray balance correction processing is the gray balance correction amount for correcting an image such that the gray image is properly displayed in gray.

In the color balance correction (frame gray balance correction) processing, the result of analyzing an image in one frame (image characteristic amount) and the gray axis are evaluated, and the color temperature correction amount and color failure correction amount on the image of the frame are calculated. Here, in the case of an image having a person shot thereon as a subject, a face region as a main subject has been extracted in previous face extraction processing, so color balance correction processing can be effected such that a color of the face region is set within a predetermined color range appropriate as a skin color, thereby obtaining high color balance correction performance.

In the under/over correction processing, a correction table for correcting a gray scale of an under region and over region of the image with the gray scale characteristic of a negative film taken into account is set by calculation. With the image data on images of a group of frames taken with the DSC 14, the correction table for correcting the image data with the gray scale characteristic taken into account is similarly set by calculation.

In the density correction processing, the density correction amount of an entire image is calculated based on the image analysis result for each frame. Also, in the case where the face detection means 58 extracts the face region through the face extraction processing, the density correction amount is calculated such that the density of the extracted face region falls within a predetermined density range. Here, the face region has been extracted in previous face extraction processing, so the density correction processing can be performed so that the density of the face region falls within a predetermined density range appropriate as a skin color, thereby attaining the high density correction performance.

Then, in the contrast correction processing, highlight and shadow density values are determined to calculate a tilt correction amount of the gray axis.

In this way, the gray scale correction amount calculated with the gray scale correction means 56 is sent to the conversion map creating means 62.

In the similar frame correction processing, the similar frame correction means 60 executes similar frame correction processing of color balance correction (frame gray balance correction), similar frame correction processing of density correction, and similar frame correction processing of contrast correction on the similar frame image (image data) whose gray scale is corrected with the gray scale correction means 56, to calculate the color balance adjustment amount, the density adjustment amount, and the contrast adjustment amount.

Here, in the similar frame correction processing of the color balance correction (frame gray balance correction), color balance correction amounts of a frame to be processed, two preceding frames and two succeeding frames (five frames in total) which are calculated with the image analysis means 54 are weight-averaged with similarity evaluation values of the frame to be processed, two preceding frames and two succeeding frames to thereby calculate the color balance adjustment amount.

In the similar frame correction processing of the density correction, density correction amounts of the frame to be processed, two preceding frames and two succeeding frames which are calculated with the image analysis means 54 are weight-averaged with similarity evaluation values of the frame to be processed, two preceding frames and two succeeding frames to thereby calculate the density adjustment amount.

In the similar frame correction processing of the contrast correction, contrast correction amounts of the frame to be processed, two preceding frames and two succeeding frames which are calculated with the image analysis means 54 are weight-averaged with similarity evaluation values of the frame to be processed, two preceding frames and two succeeding frames to thereby calculate the contrast adjustment amount.

In this way, each adjustment amount calculated with the similar frame correction means 60 is sent to the conversion map creating means 62.

In the above embodiment, in the gray scale correction processing carried out with the gray scale correction means 56, the face extraction processing is performed using gray information in the face detection means 58, so the face extraction processing comes first. However, the present invention is not limited thereto, and the face extraction processing may be performed after the load-basis gray balance correction, frame gray balance correction, or under/over correction.

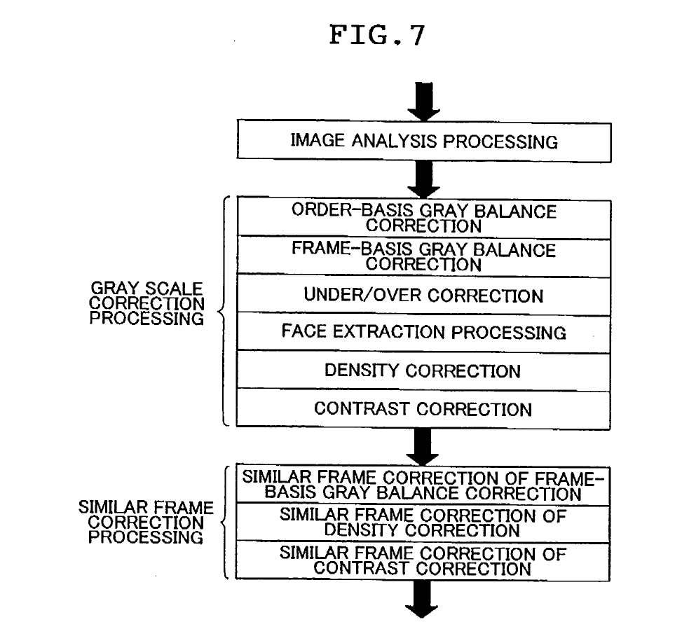

FIG. 7 is a flowchart showing another example of the flow of calculation processing for gray scale correction amounts and gray scale adjustment amounts carried out in the image setup apparatus.

An example illustrated in FIG. 7 has the same structure as that of the example illustrated in FIG. 6 except that the face extraction processing is performed after the load-basis gray balance correction, frame gray balance correction, and under/over correction, not coming first in the gray scale correction processing, so explanation of the same portions or detailed description of equivalent portions is omitted, and the following description is focused on the difference therebetween.

In the gray scale correction processing shown in FIG. 7, the gray scale correction means 56 performs the load-basis gray balance correction (gray balance correction), frame gray balance correction (color balance correction), under/over correction, face extraction, density correction, and contrast correction on the input image data in this order for image gray scale correction to thereby calculate various gray scale correction amounts.

In the gray balance correction (load-basis gray balance correction) processing, as in the example illustrated in FIG. 6, the gray axis is optimized/approximated to calculate the gray balance correction amount.

In the frame gray balance correction (color balance correction) processing, a result of analyzing an image in one frame and the gray axis are evaluated, and the color temperature correction amount and color failure correction amount on the image of the frame are calculated. In this example, since the face region is not extracted at that moment, the color balance correction processing cannot be performed such that the color of the face region falls within a predetermined color range appropriate as a skin color, but except this point, the color balance correction amount can be calculated as in the example illustrated in FIG. 6.

Even in the under/over correction processing, as in the example illustrated in FIG. 6, a correction table for correcting gray scales of the under region and over region of the image is set by calculation.

In the face extraction processing, the face detection means 58 extracts a face region of a person as a subject based on skin color information in image data subjected to color balance correction. Note that in this example, the face extraction processing with the face detection means 58 can be performed based on skin color information in image data subjected to the color balance correction as well as the gray information, and thus the processing can be effected more easily or accurately than the example illustrated in FIG. 6. Note that information on the face region extracted in the face extraction processing is sent to the face detection means 22 of the red-eye detection apparatus 10 as in the example illustrated in FIG. 6.

In the density correction processing, as in the example illustrated in FIG. 6, the density correction amount is calculated such that the density of the face region extracted through face extraction falls within a predetermined density range.

Even in the contrast correction processing, as in the example illustrated in FIG. 6, highlight and shadow density values are determined, and the tilt correction amount of a gray axis is calculated.

In this way, each correction amount calculated with the gray scale correction means 56 is sent to the conversion map creating means 62.

Next, in the similar frame processing, as in the example illustrated in FIG. 6, the similar frame correction means 60 weight-averages color balance correction amounts of a frame to be processed, two preceding frames and two succeeding frames (five frames in total) based on the similarity (similarity evaluation values) to thereby calculate the color balance adjustment amount, the density adjustment amount, and the contrast adjustment amount.

Each adjustment amount calculated with the similar frame correction means 60 is sent to the conversion map creating means 62.

Thus, in either of the examples illustrated in FIGS. 6 and 7, each correction amount calculated with the gray scale correction means 56 and each adjustment amount calculated with the similar frame correction means 60 are sent to the conversion map creating means 62 as shown in FIG. 5, and a conversion map (conversion function, LUT, conversion matrix, etc.) of a gray scale LUT, a similar frame correction LUT (gray balance correction LUT or color balance correction LUT), or the like is automatically created and set.

Next, in the conversion means 64, the fine-scan data inputted to the image processor 50 is converted in accordance with the automatically set conversion map (conversion function, LUT, conversion matrix, etc.) to obtain set-up image data.

Thus, in the image setup apparatus 52, the image condition setting and conversion processing (auto-setup processing) are executed to obtain the set-up image data or data on clipped face region.

In this way, the set-up image data and prescan data obtained by the image setup apparatus 52 are inputted to the data processing means 18 of the red-eye detection apparatus 10. Note that as mentioned above, the data on clipped face region obtained with the face detection means 58 is also inputted to the face detection means 22 of the red-eye detection apparatus 10 directly or through the data processing means 18.

In the image processor 50 shown in FIG. 5, the red-eye detection apparatus 10 obtains from the image setup apparatus 52, the prescan data or set-up (processed) image data subjected to image processing (auto-setup processing) as mentioned above, and the face detection means 22 of the red-eye detection apparatus 10 can receive from the gray scale correction means 56 of the image setup apparatus 52, the data on clipped face region as a face extraction result obtained in the face detection means 58 directly or through the data processing means 18 of the red-eye detection apparatus 10.

The red-eye detection apparatus 10 of the image processor 50 shown in FIG. 5 has just the same structure as the red-eye detection apparatus 10 of the embodiment shown in FIG. 1 except that image data (fine-scan data and prescan data) of a target image is not obtained from an image data source like the scanner 12 or DSC 14 but the set-up image data and prescan data are obtained from the image setup apparatus 52, and that data on the clipped face region obtained with the face detection means 58 of the gray scale correction means 56 in the image setup apparatus 52 is used when the face detection means 22 performs face detection. Hence, like components are denoted by like numerals, so the detailed description is omitted, and the following description is focused on the difference therebetween.

In the image processor 50 shown in FIG. 5, the face detection means 22 of the red-eye detection apparatus 10 can detect a face only in a region surrounding a red eye candidate detected by the red-eye candidate detection means 20 using data on the clipped face region obtained by the face detection means 58 of the gray scale correction means 56 in the image setup apparatus 52. The face detection in the face detection means 22 of the red-eye detection apparatus 10 is based on previously obtained data on clipped face region, so the time-consuming face detection can be performed with considerably small calculation amounts, that is, within an extremely short period of time, with high accuracy and efficiency.

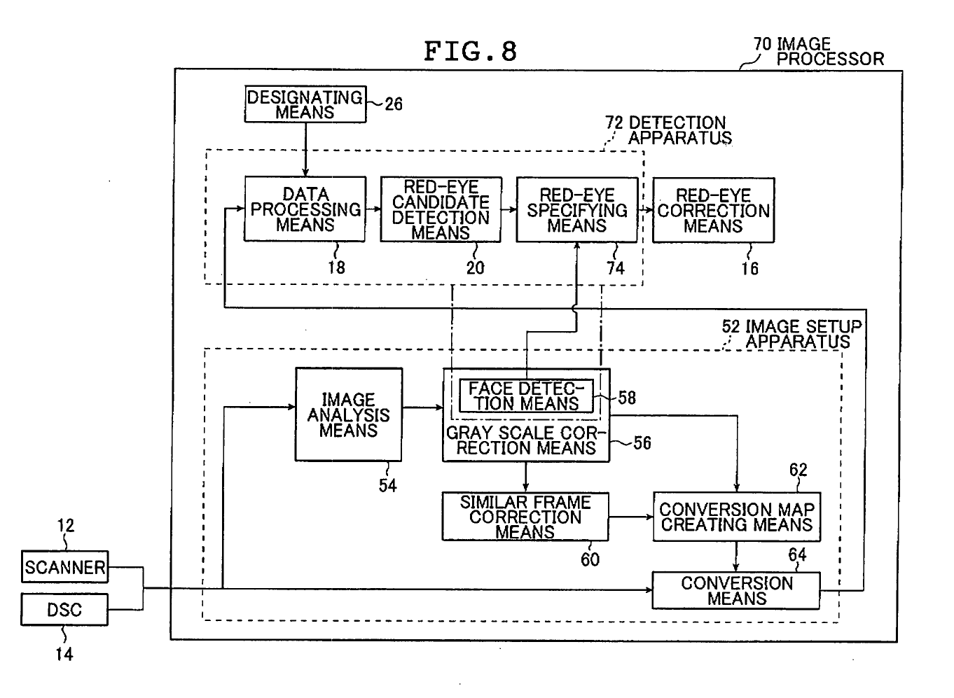

In the image processor 50 shown in FIG. 5, the face detection means 58 of the gray scale correction means 56 in the image setup apparatus 52 executes the face detection (face extraction processing), and the face detection means 22 of the red-eye detection apparatus 10 also executes the face detection using obtained data on the clipped face region. However, the present invention is not limited to this, and as in an image processor 70 shown in FIG. 8, data on the clipped face region obtained in the face detection means 58 of the gray scale correction means 56 in the image setup apparatus 52 may be used without setting separate face detection means in the red-eye detection apparatus 10, or the face detection means 58 may also double as the face detection means of the red-eye detection apparatus 10.

FIG. 8 is a block diagram of another embodiment of an image processor including a red-eye detection apparatus to which a particular-region detection apparatus implementing a particular-region detection method of the present invention is applied.

The image processor 70 shown in FIG. 8 has the same structure as the image processor 50 shown in FIG. 5 except that a red-eye detection apparatus 72 is not provided with the face detection means 22, and data on the clipped face region obtained in the face detection means 58 of the gray scale correction means 56 in the image setup apparatus 52 is directly inputted to the red-eye specifying means 74. Hence, like components are denoted by like numerals, and their explanation is omitted.

In this embodiment, the image processor 70 includes the image setup apparatus 52, the red-eye detection apparatus 72, the red-eye correction means 16, and the designating means 26.

Further, the red-eye detection apparatus 72 includes the data processing means 18, the red-eye candidate detection means 20, a red-eye specifying means 74, and the designating means 26 externally connected, or includes the data processing means 18, the red-eye candidate detection means 20, the red-eye specifying means 24, the designating means 26 externally connected, and the face detection means 58 doubling as the face detection means of the image setup apparatus 52.

In the red-eye specifying means 74 of the red-eye detection apparatus 72, it is judged whether or not the red-eye candidates detected by the red-eye candidate detection means 20 are included in a clipped face region by using data on the clipped face region obtained in the face detection means 58 of the gray scale correction means 56 of the image setup apparatus 52. After that, the positional information on the red-eye candidates is compared with the region information on the clipped face region, for example, and a red-eye candidate included in the face region is specified as a red-eye region to be detected.

In this embodiment, for example, the face extraction processing in the face detection means 58 is basically performed on low-resolution image data such as prescan data, and the data on the clipped face region obtained in the face detection means 58 is low-resolution image data. In contrast, the red-eye candidate detection with the red-eye candidate detection means 20 is performed on the high-resolution image data such as fine-scan data which is different in resolution. Therefore, the red-eye specifying means 74 is provided with a scale conversion means (not shown) and it is necessary that data on the clipped face region obtained in the face detection means 58 be converted in resolution from low-resolution image data to high-resolution image data for adjusting the resolution, data interpolation be performed on the data on the clipped face region to increase the pixel density, that is, enlarge the image size, and scale conversion be performed so as to obtain the pixel density or size of the high-resolution image data such as the fine-scan data.

Thus, in the red-eye detection apparatus 72 of this embodiment as well, the red-eye specifying means 74 can check whether or not a red-eye candidate detected in the red-eye candidate detection means 20 is included in the face region clipped in the face detection means 58, and the red-eye candidate in the face region can be specified as a red-eye region to be detected.

The particular-region detection method and particular-region detection apparatus according to the present invention are basically as discussed above.

According to the present invention, a particular-region detection program may be configured to cause a computer to execute each step of the particular-region detection method or to cause a computer to function as each means of the particular-region detection apparatus.

The particular-region detection method, apparatus, and program of the present invention have been described so far in detail based on various embodiments. However, those embodiments are in no way limitative of the present invention, and needless to say, various improvements and modifications can be made without departing from the gist of the present invention.

For example, given above is an embodiment where the detection method of the present invention is applied to the red-eye detection. However, the present invention is not limited to this, and a variety of any possible objects in a face region of an image such as golden eyes, eyes, eye corners, eyebrows, a mouth, a nose, glasses, pimples, moles, and wrinkles may be set as particular regions. For example, pimple candidates may be detected from the image, face detection may be performed in a region surrounding the pimple candidates, and a pimple candidate around which a face could be detected may be specified as pimples.

An example of a detection method for the particular-region candidates in this case is a method in which a region having a color or a shape specific to a particular region to be detected is detected from an image. A matching method is also preferable which uses an image (template) for an average particular region previously created from a large number of image samples of the particular regions to be detected. For example, an method may be used in which an average image of an eye corner previously created from a large number of eye corner image samples, that is, an eye corner template is used for matching to thereby detect the eye corner.

1. A method of detecting particular regions, comprising:
detecting one or more particular region candidates in a first image;
performing face detection in a region including at least one of the thus detected one or more particular region candidates by using a second image having a scene as same as said first image in which said one or more particular region candidates are detected, but being different in resolution from said first image; and
specifying as a particular region of a detection target a particular region candidate that is included in said region where a face can be detected.

2. The method of detecting particular regions according to claim 1, wherein said particular regions include a region of a red eye or a golden eye.

3. The method of detecting particular regions according to claim 1, wherein said first image in which said one or more particular region candidates are detected is a high-resolution image and said second image in which said face detection is performed is a low-resolution image.

4. The method of detecting particular regions according to claim 1, wherein said first image in which said one or more particular region candidates are detected is a low-resolution image and said second image in which said face detection is performed is a high-resolution image.

5. The method of detecting particular regions according to claim 3, wherein:
said high-resolution image includes one of first image data on an image taken by a digital camera and second image data obtained through fine scanning of an original image for producing an output image in an image reader; and
said low-resolution image includes one of third image data obtained by thinning out pixels or reducing a size of said first image data taken by said digital camera, and fourth image data obtained through pre-scanning of said original image performed prior to said fine scanning in said image reader.

6. The method of detecting particular regions according to claim 1, wherein said face detection is performed using data of face region clipping processing used to image density correction, said face region clipping processing being carried out prior to detection of said one or more particular region candidates.

7. A method of detecting particular regions, comprising:
detecting one or more particular region candidates from a first image in fed image data;
performing, prior to detection of said one or more particular region candidates, clipping processing of a face region for using to image density correction using a second image having a scene as same as said first image in which said one or more particular region candidates are detected, but being different in resolution from said first image;
checking whether or not one of said one or more particular region candidates is included within said face region clipped by said face region clipping processing; and
specifying as a particular region of a detection target a particular region candidate that is included within said face region.

8. An apparatus for detecting particular regions, comprising:
candidate detection means for detecting one or more particular region candidates from a first image in fed image data;
face detection means for detecting a face in a region including said one or more particular region candidates detected by said candidate detection means by using a second image having a scene as same as said first image in which said one or more particular region candidates are detected by said candidate detection means, but being different in resolution from said first image; and
specifying means for specifying as a particular region of a detection target a particular region candidate that is included in said region where a face can be detected by said face detection means.

9. The apparatus for detecting particular regions according to claim 8, wherein said particular regions include a region of a red eye or a golden eye.

10. The apparatus for detecting particular regions according to claim 8, further comprising selecting means for selecting one of a first detection mode in which said candidate detection means performs detection with a high-resolution image and said face detection means performs detection with a low-resolution image, and a second detection mode in which said candidate detection means performs detection with said low-resolution image and said face detection means performs detection with said high-resolution image.

11. The apparatus for detecting particular regions according to claim 10, wherein:
said high-resolution image includes one of first image data on an image taken by a digital camera and second image data obtained through fine scanning of an original image for producing an output image in an image reader; and
said low-resolution image includes one of third image data obtained by thinning out pixels or reducing a size of said first image data taken by said digital camera, and fourth image data obtained through pre-scanning of said original image performed prior to said fine scanning in said image reader.

12. The apparatus for detecting particular regions according to claim 8, wherein said face detection means performs face detection using data of face region clipping processing used to image density correction, said face region clipping processing being carried out prior to detection of said one or more particular region candidates.

13. An apparatus for detecting particular regions, comprising:
candidate detection means for detecting one or more particular region candidates from a first image in fed image data;
face detection means for performing, before said one or more particular region candidates is detected in said candidate detection means, clipping processing of a face region for using to image density correction using a second image having a scene as same as said first image in which said one or more particular region candidates are detected in said candidate detection means, but being different in resolution from said first image; and
specifying means for checking whether or not one of said one or more particular region candidates detected by said candidate detection means is included within said face region clipped by said face detection means, and specifying as a particular region of a detection target a particular region candidate that is included within said face region.

14. A program for detecting particular regions, which causes a computer to execute:
a candidate detection step of detecting one or more particular region candidates from a first image in fed image data;
a face detection step of detecting a face in a region including said one or more particular region candidates detected in said candidate detection step by using a second image having a scene as same as said first image in which said one or more particular region candidates are detected in said candidate detection step, but being different in resolution from said first image; and
a specifying step of specifying as a particular region of a detection target a particular region candidate that is included in said region where a face can be detected in said face detection step.

15. The program for detecting particular regions according to claim 14, wherein said particular regions include a region of a red eye or a golden eye.

16. The program for detecting particular regions according to claim 14, wherein said first image in which said one or more particular region candidates are detected is a high-resolution image and said second image in which said face detection is performed is a low-resolution image.

17. The program for detecting particular regions according to claim 14, wherein said first image in which said one or more particular region candidates are detected is a low-resolution image and said second image in which said face detection is performed is a high-resolution image.

18. The program for detecting particular regions according to claim 16, wherein:
said high-resolution image includes one of first image data on an image taken by a digital camera and second image data obtained through fine scanning of an original image for producing an output image in an image reader; and
said low-resolution image includes one of third image data obtained by thinning out pixels or reducing a size of said first image data taken by said digital camera, and fourth image data obtained through pre-scanning of said original image performed prior to said fine scanning in said image reader.

19. The program for detecting particular regions according to claim 14, wherein said face detection is performed using data of face region clipping processing used to image density correction, said face region clipping processing being carried out prior to detection of said one or more particular region candidates.

20. A program for detecting particular regions, which causes a computer to execute:
a candidate detection step of detecting one or more particular region candidates from a first image in fed image data;
a face detection step of performing, before said one or more particular region candidates is detected in said candidate detection means, clipping processing of a face region for using to image density correction using a second image having a scene as same as said first image in which said one or more particular region candidates are detected in said candidate detection step, but being different in resolution from said first image;
a checking step of checking whether or not one of said one or more particular region candidates detected by said candidate detection step is included within said face region clipped by said face detection step; and
a specifying step of specifying as a particular region of a detection target a particular region candidate that is included within said face region.
